(19) United States
(12) Patent Application Publication
(10) Pub. No.: US 2025/0209789 A1
(43) Pub. Date: Jun. 26, 2025

(54) CAMERA BASED OBJECT DETECTING APPARATUS WITH NO INVASION OF PRIVACY

(71) Applicants: Shin Hwan HWANG, Seoul (KR); Hee Jeong Choi HWANG, Yongin-si (KR); Yoon Joong HWANG, Yongin-si (KR)

(72) Inventors: Shin Hwan HWANG, Seoul (KR); Hee Jeong Choi HWANG, Yongin-si (KR); Yoon Joong HWANG, Yongin-si (KR)

(73) Assignee: Shin Hwan HWANG, Seoul (KR)

(21) Appl. No.: 18/393,768

(22) Filed: Dec. 22, 2023

(51) Int. Cl. G06V 10/764; G06V 10/774; G06V 10/82

(52) U.S. Cl. CPC G06V 10/764; G06V 10/774; G06V 10/82; G06V 2201/10

(57) ABSTRACT

Disclosed is a technique capable of identifying the features of the shape or motion of an object in an image input from a camera. The camera includes an optical distortion element provided in front of an image sensor, wherein the optical distortion element is configured to distort light reflected from an object to a level that cannot be recognized by humans and to allow the distorted light to pass therethrough. It is not possible for the human eye to detect the object from the distorted image, but the object may be detected from the distorted image by an intelligent image processor trained with a distorted image signal and information about the object. An object detection learning apparatus trains the object detection apparatus using a distorted image obtained by optically distorting a labeled image in the same manner as the object detection apparatus and a label of the original image.

### BACKGROUND OF THE INVENTION

### Field of the Invention

The present invention relates to a technique capable of processing an image input from a camera, and more particularly to a technique capable of identifying the features of the shape or motion of an object in an image.

### Description of the Related Art

Technology for processing an image input from camera using an intelligent computing device to detect the features of the shape of an object or the features of the motion of the object is known. An example of the features of the shape may be the type of an object. For example, a person, a bicycle, and an animal may be distinguished from each other. Another example of the features of the shape may be the shape of a person. For example, whether the person wears a hat, how tall the person is, whether the person is male or female, or whether the person is an adult and a child may be determined. A further example of the features of the shape may be facial expression of a person. For example, whether the person is angry, smiling, or happy may be determined, and personal identification may be performed. The features of the motion may include, for example, running, crossing a certain boundary, moving in a group, moving of the group in the same direction, or a predetermined number or more of people in a line. Object detection technology is important for many purposes, such as security or gathering information for marketing, but with advances in computerized intelligence processing, invasion of privacy is becoming increasingly serious.

### SUMMARY OF THE INVENTION

It is an object of the present invention to provide a new object identification technique capable of collecting information while identifying static features or dynamic features of an object in an image captured by a camera with no invasion of privacy.

It is another object of the present invention to an object identification technique capable of adopting existing image processing techniques without significant changes.

In an aspect, a camera includes an optical distortion element provided in front of an image sensor, wherein the optical distortion element is configured to distort light reflected from an object to a level that cannot be recognized by humans and to allow the distorted light to pass therethrough. It is not possible for the human eye to detect the object from the distorted image, but the object may be detected from the distorted image by an intelligent image processor trained with a distorted image signal and information about the object.

In another aspect, an object detection learning apparatus trains the object detection apparatus using a distorted image obtained by optically distorting a labeled image in the same manner as the object detection apparatus and a label of the original image.

In a further aspect, there is provided an object detection learning apparatus for distorting an undistorted image through the optical distortion element with general learning data including the undistorted image and label data thereof to train an object detection apparatus to be trained.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the configuration of an object detection apparatus according to an embodiment;

FIG. 2 is a block diagram showing the configuration of an object detection learning apparatus according to an English Translation U.S. application Ser. No. 18/393,768 embodiment; and

FIG. 3 is a block diagram showing the configuration of an object detection learning apparatus according to another embodiment.

### DETAILED DESCRIPTION OF THE INVENTION

The foregoing and additional aspects are embodied in embodiments described with reference to the accompanying drawings. It is understood that components of each embodiment may be variously combined in the embodiment or may be variously combined with components of other embodiments, unless mentioned otherwise or mutually inconsistent. It should be understood that the terms or words used in the specification and appended claims should be construed based on meanings and concepts according to the technical idea of the present invention on the basis of the principle that the inventor can appropriately define the concept of terms in order to best describe their invention. Hereinafter, preferred embodiments of the present invention will be described in detail with reference to the accompanying drawings.

<Invention Defined by Claims 1, 2, and 3>

In an aspect, a camera includes an optical distortion element provided in front of an image sensor, wherein the optical distortion element is configured to distort light reflected from an object to a level that cannot be recognized by humans and to allow the distorted light to pass therethrough. It is not possible for the human eye to detect the object from the distorted image, but the object may be detected from the distorted image by an intelligent image processor trained with a distorted image signal and information about the object.

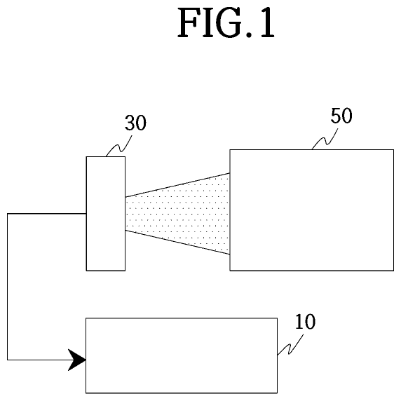

FIG. 1 is a view showing the configuration of an object detection apparatus according to an embodiment. As shown, the object detection apparatus according to the embodiment includes an optical distortion element 50, an image sensor 30, and an intelligent image processor 10. The optical distortion element distorts light reflected from an object to a level that cannot be recognized by humans and allows the distorted light to pass therethrough.

In an embodiment, the optical distortion element 50 may be a lens with a plurality of regions, each having an incident surface that is sloped at an irregular angle. In another embodiment, the optical distortion element 50 may be a lens barrel including a plurality of lens disposed so as to overlap each other. In another embodiment, the optical distortion element 50 may have a configuration in which each region of a light incident surface divided into a plurality of regions is connected to a corresponding region of a light exit surface divided into the same number of regions via an optical cable while being mapped in an irregular relationship. In a further embodiment, the optical distortion element 50 may be a combination of at least one of the elements according to the above embodiments and at least one optical element, such as a general optical lens, a reflector, a prism, or a half-mirror.

If the optical distortion element 50 has an appearance similar to a lens of a typical camera even though the optical distortion element 50 has a structure that is not actually capable of capturing real images, people familiar with the typical camera may misunderstand or feel uneasy that their privacy is being exposed.

Therefore, the object detection apparatus may have a different shape from the typical camera, for example, a cubic shape that looks opaque on all sides. In this case, the optical distortion element 50 may be made of an opaque, translucent material, and may have a flat front surface and an irregularly curved rear surface. Accordingly, some of light incident on the optical distortion element 50 is diffusely reflected, and some of the incident light reaches the image sensor while being irregularly refracted.

In another example, numerous slits may be irregularly arranged in an opaque plane. In a further example, microscopic holes each having a geometric shape, such as “*” or “+”, may be irregularly and densely arranged at the opaque plane.

The image sensor 30 receives the distorted light from the optical distortion element, converts the distorted light into an electrical image signal, and outputs the electrical image signal. In an embodiment, the image sensor 30 is a CMOS image sensor (CIS). However, the present invention is not limited thereto, and the image sensor may be a photoelectric conversion element configured to convert a 2D or 3D image into an electrical signal or a depth camera configured to provide a depth image along with a visual image.

The intelligent image processor 10 learns the distorted image signal and information about the object, processes the electrical image signal output from the image sensor, and outputs computational results for optical features of the object. In an aspect, the intelligent image processor 10 may be an intelligent classifier configured to classify the shape of the object into one of a plurality of categories. For example, the intelligent image processor 10 may include one plurality of organically structured artificial intelligence processors configured to execute a deep learning algorithm. In the embodiment shown, the deep learning algorithm is an artificial intelligence processor implementing one of known convolutional neural network (CNN)-based algorithms.

In an aspect, the intelligent image processor 10 may be trained with the distorted image signal and information about the object.

### <Invention Defined by Claims 4 and 5>

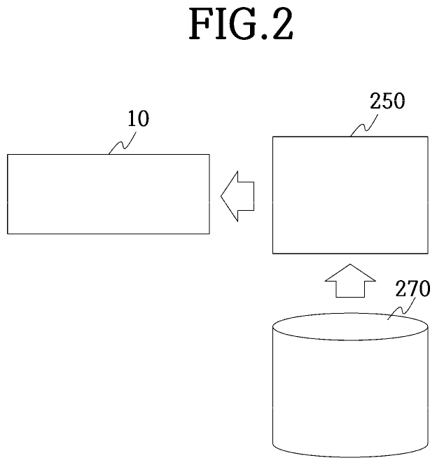

In another aspect, an object detection learning apparatus trains the object detection apparatus using a distorted image obtained by optically distorting a labeled image in the same manner as the object detection apparatus and a label of the original image. FIG. 2 is a block diagram showing the configuration of an object detection learning apparatus according to an embodiment to which this aspect is applied. The shown learning apparatus may be implemented by a computing device including a memory, a processor, and software for control. As shown, the object detection learning apparatus according to the embodiment includes a learning database 270 and a distorted image learning unit 250. The learning database 270 stores distorted image data obtained by distorting the original image to a level that cannot be recognized by humans and metadata regarding optical features of an object included in the original image in a state of being mapped to each other. Here, the metadata includes data commonly referred to as a label in the field of artificial intelligence. Since a plurality of optical features in a single image may be detected or identified, a plurality of labels may be mapped to single image data. Additionally, the metadata may include data capable of distinguishing between the natures of the optical features of the object, for example, the natures of the label, such as dynamic/static features and the shape of the boundary for intrusion detection. Image data stored in the learning database 270 may be still images or video clips of a certain length.

In this specification, the object may be an object that is subject to privacy concerns, such as a person. However, the present invention is not limited thereto, and the object detection apparatus may be required to identify or determine various types of objects other than people, such as animals, plants, buildings, and articles, among a plurality of objects included in an image. For example, the object detection apparatus may be required to distinguish one of a person, an animal, a bicycle, and a car from the others. Therefore, the intelligent image processor may be trained to detect different kinds of objects, as well as people, in order to collect required information.

The distorted image learning unit 250 sequentially outputs distorted image data obtained by distorting the original image to a level that cannot be recognized by humans and label data mapped to the original image to train the intelligent image processor. In an embodiment, the intelligent image processor may include a convolutional neural network, and the distorted image learning unit 250 may be a reinforcement learning engine configured to train the intelligent image processor including the convolutional neural network with the distorted image data and the label data stored in the learning database 270.

### <Invention Defined by Claim 6>

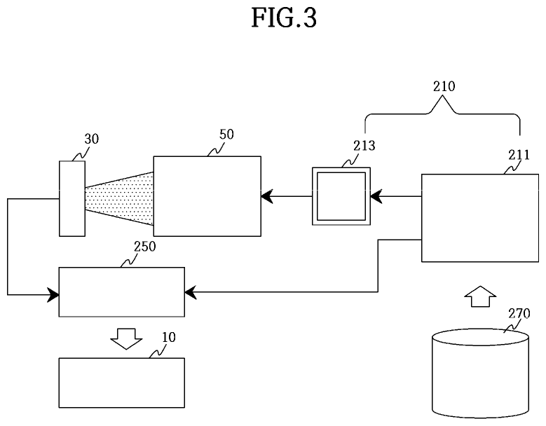

In a further aspect, there is provided an object detection learning apparatus for distorting an undistorted image through the optical distortion element with general learning data including the undistorted image and label data thereof to train an object detection apparatus to be trained. FIG. 3 is a block diagram showing the configuration of an object detection learning apparatus according to another embodiment to which this aspect is applied. In the figure, components that are similar or identical to corresponding components of the apparatus shown in FIG. 1 or 2 are denoted by the same reference numerals.

As shown, the object detection learning apparatus according to the embodiment includes a learning database 270, an image playback unit 210, an optical distortion element 50, an image sensor 30, and a distorted image learning unit 250. The learning database 270 stores image data and metadata related to optical features of an object included in of an image of the image data in a state of being mapped to each other. Here, the metadata includes data commonly referred to as a label in the field of artificial intelligence. Since a plurality of optical features in a single image may be detected or identified, a plurality of labels may be mapped to single image data. Additionally, the metadata may include data capable of distinguishing between the natures of the optical features of the object, for example, the natures of the label, such as dynamic/static features and the shape of the boundary for intrusion detection. Image data stored in the learning database 270 may be still images or video clips of a certain length. The learning database is already available in large quantities from many organizations.

In this specification, the object may be an object that is subject to privacy concerns, such as a person. However, the present invention is not limited thereto, and the object detection apparatus may be required to identify or determine various types of objects other than people, such as animals, plants, buildings, and articles, among a plurality of objects included in an image. For example, the object detection apparatus may be required to distinguish one of a person, an animal, a bicycle, and a car from the others. Therefore, the intelligent image processor may be trained to detect different kinds of objects, as well as people, in order to collect required information.

The image playback unit 210 plays and outputs the image data, and outputs label data among the metadata related to the image data in a state of being synchronized at the time of output. In an embodiment, the image playback unit 210 may include a synchronized playback unit 211 and a display 213. The synchronized playback unit 211 reads image data and metadata mapped thereto from the learning database 270, plays the image data, and outputs the metadata in synchronization with the playback and output of the image. The synchronized playback unit 211 may extract, particularly, label data related to optical aspects to be learned by the intelligent image processor currently being trained, among the metadata, and may output the label data.

The optical distortion element 50 distorts light reflected from an object to a level that cannot be recognized by humans and allows the distorted light to pass therethrough. In an embodiment, the optical distortion element 50 may be a lens with a plurality of regions, each having an incident surface that is sloped at an irregular angle. In another embodiment, the optical distortion element 50 may be a lens barrel including a plurality of lenses disposed so as to overlap each other. In another embodiment, the optical distortion element 50 may have a configuration in which each region of a light incident surface divided into a plurality of regions is connected to a corresponding region of a light exit surface divided into the same number of regions via an optical cable while being mapped in an irregular relationship. In a further embodiment, the optical distortion element 50 may be a combination of at least one of the elements according to the above embodiments and at least one optical element, such as a general optical lens, a reflector, a prism, or a half-mirror.

The image sensor 30 receives the distorted light from the optical distortion element, converts the distorted light to an electrical image signal, and outputs the electrical image signal. In an embodiment, the image sensor 30 is a CMOS image sensor (CIS). However, the present invention is not limited thereto, and the image sensor may be a photoelectric conversion element configured to convert a 2D or 3D image into an electrical signal or a depth camera configured to provide a depth image along with a visual image.

The distorted image learning unit 250 provides metadata related to the original image data and the distorted image signal output from the image sensor to train the intelligent image processor. Similarly to the previous embodiment, the distorted image learning unit 250 of the shown learning apparatus may be implemented by a computing device including a memory, a processor, and software for control.

In an embodiment, the intelligent image processor may include a convolutional neural network, and the distorted image learning unit 250 may be a reinforcement learning engine configured to train the intelligent image processor including the convolutional neural network with the distorted image data and the label data stored in the learning database 270.

As is apparent from the above description, according to the present invention, a camera image is acquired in a distorted state that is incomprehensible to the human eye, but may be interpreted by an artificial intelligence-based object detection apparatus trained with distorted images. Consequently, it is possible to collect information for various purposes and uses, such as demographic, commercial, and security purposes, while protecting the privacy of individuals.

The present invention has been described above based on the embodiments with reference to the accompanying drawings, but is not limited thereto, and should be construed to encompass a variety of variations that will be apparent to those skilled in the art. The claims are intended to cover such variations.

1. A camera-based object detection apparatus comprising:
an optical distortion element configured to distort light reflected from an object to a level that cannot be recognized by humans and to allow the distorted light to pass therethrough;
an image sensor configured to receive the distorted light from the optical distortion element, to convert the distorted light into an electrical image signal, and to output the electrical image signal; and
an intelligent image processor configured to learn the distorted image signal and information about the object, to process the electrical image signal output from the image sensor, and to output computational results for optical features of the object.

2. The camera-based object detection apparatus according to claim 1, wherein the optical distortion element is an optical scrambling element comprising a lens with a plurality of regions, each having an incident surface that is sloped at an irregular angle.

3. The camera-based object detection apparatus according to claim 1, wherein the optical distortion element is an element having an opaque planar shape.

4. The camera-based object detection apparatus according to claim 1, wherein the intelligent image processor is an intelligent classifier configured to classify a shape of the object into one of a plurality of categories.

5. An object detection learning apparatus for training an intelligent image processor, the object detection learning apparatus comprising a distorted image learning unit configured to sequentially output distorted image data obtained by distorting an original image to a level that cannot be recognized by humans and label data mapped to the original image in order to train the intelligent image processor.

6. The object detection learning apparatus according to claim 5, further comprising a learning database configured to store distorted image data obtained by distorting an original image to a level that cannot be recognized by humans and metadata regarding optical features of an object included in the original image in a state of being mapped to each other.

7. An object detection learning apparatus for training an intelligent image processor, the object detection learning apparatus comprising:
a learning database configured to store image data and metadata related to optical features of an object included in an image of the image data in a state of being mapped to each other;
an image playback unit configured to play and output the image data and to output the metadata related to the image data in a state of being synchronized at the time of output;
an optical distortion element configured to distort the image played by the image playback unit to a level that cannot be recognized by humans and to allow the distorted image to pass therethrough;
an image sensor configured to receive the distorted image from the optical distortion element, to convert the distorted image into a distorted image signal, and to output the distorted image signal; and
a distorted image learning unit configured to provide metadata related to original image data and the distorted image signal output from the image sensor to train the intelligent image processor.

8. The object detection learning apparatus according to claim 7, wherein the optical distortion element is an optical scrambling element comprising a lens with a plurality of regions, each having an incident surface that is sloped at an irregular angle.

9. The object detection learning apparatus according to claim 8, wherein the optical distortion element is an element having an opaque planar shape.
